(19) United States
(12) Patent Application Publication
(10) Pub. No.: US 2010/0153191 A1
(43) Pub. Date: Jun. 17, 2010

(54) VARIABLE TOLL FEE SELECTION FROM GEOGRAPHIC INDICIA

(75) Inventors: Rick A. Hamilton, II, Charlottesville, VA (US); Naveen Lamba, Haymarket, VA (US); Benjamin G. Morris, Falls Church, VA (US); James W. Seaman, Falls Chruch, VA (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/336,587

(22) Filed: Dec. 17, 2008

(51) Int. Cl. G07B 15/00

(52) U.S. Cl. 705/13

(57) ABSTRACT

Methods, including service methods, systems, articles, programmable devices and articles of manufacture are provided for selecting and applying variable thoroughfare travel fees. Each of a plurality of differentiated impacts associated with a toll thoroughfare are determined, each of the impacts different from another. Each of the impacts are correlated with geographic impact regions, each impact region is proximate to the toll thoroughfare and geographically distinct from another. Travel fees are assigned to each impact region, each assigned impact region travel fee different from another. Use of the toll thoroughfare by a traveler is determined, a relation of the traveler to one of the impact regions identified and a toll is charged as a function of the determined toll thoroughfare use and the travel fee of the associated impact region.

### FIELD OF THE INVENTION

The present invention generally describes methods, systems and devices for providing variable thoroughfare travel fees. More particularly, a rate may be selected as a function of geographic criteria associated with a user.

### BACKGROUND OF THE INVENTION

Large traffic volumes on public thoroughfares may cause a number of problems. In one example traffic congestion and environmental impacts from vehicle emissions and other pollution generated by vehicle large traffic volumes on public roadways may cause a variety of negative impacts. In order to improve quality of life for users of thoroughfares, as well as for people and areas impacted by their use and operation, it is desired to manage traffic volumes. However, traffic management may be difficult and complex.

More particularly, thoroughfare users have many different travel requirements, options, and habits. Roadway networks may include public roads, regional and intrastate highways, interstate highways, public toll and access roads, private toll and access roads, and each road in a given network may be negatively impacted by traffic carried by or diverted from another road. Traffic problems are not limited to roadways, and other forms of public/mass transportation thoroughfares include canals, bridges and ferries, and users may convey themselves by variety of apparatuses (e.g. tram, train, bus, lorry, bicycle, taxicab, boat, plane, etc.) as well as by foot as pedestrians.

It is known to set user fees as a function of traffic volume for a given fee-for-use thoroughfare, for example to discourage use and thereby reduce traffic volume on a turnpike by raising toll fees, or to encourage additional use by lowering fees (in some example to attract vehicular traffic from other roadways). However, management specific to one thoroughfare may also have a direct or indirect negative impact on other thoroughfares or areas. More particularly, successful management of traffic on any one thoroughfare may directly or indirectly cause other traffic-related problems with respect to another thoroughfare or area, and thus a solution ameliorating a given set of traffic volume problems on one thoroughfare may only transfer the problem to another thoroughfare, or even create new problems.

### SUMMARY OF THE INVENTION

Methods are provided for selecting and applying variable thoroughfare travel fees. Each of a plurality of differentiated impacts associated with a thoroughfare are determined, each of the impacts different from another. Each of the impacts are correlated with geographic impact regions, each impact region is proximate to the thoroughfare and geographically distinct from another. Travel fees are assigned to each impact region, each assigned impact region travel fee different from another. Use of the thoroughfare by a traveler is determined, a relation of the traveler to one of the impact regions identified and a travel fee is charged as a function of the determined thoroughfare use and the travel fee of the associated impact region.

In another aspect, service methods are provided comprising deploying applications for selecting and applying variable thoroughfare travel fees according to the method steps described above, for example by a service provider who offers to implement, deploy, and/or perform functions for others. Still further, articles of manufacture comprising a computer usable medium having a computer readable program in said medium are provided. Such program code comprises instructions which, when executed on a computer system, cause the computer system to perform one or more method and/or process elements described above for selecting and applying variable thoroughfare travel fees. Moreover, systems, articles and programmable devices configured for performing one or more method and/or process elements of the current invention are also provided for selecting and applying variable thoroughfare travel fees, for example as described above.

### BRIEF DESCRIPTION OF THE DRAWINGS

These and other features of the methods, systems and devices according to the present application will be more readily understood from the following detailed description of the various aspects of the embodiments taken in conjunction with the accompanying drawings in which:

FIG. 1 is a flow chart illustrating a method and system for selecting and applying variable thoroughfare travel fees according to the present invention.

FIG. 2 is diagrammatic illustration of an implementation of a method and system for selecting and applying variable thoroughfare travel fees according to the present invention.

FIG. 3 is a diagrammatic illustration of an implementation of a method and system for selecting and applying variable thoroughfare travel fees according to the present invention.

FIG. 4 is a block diagram of a system or device configured to enable the selection and application of variable thoroughfare travel fees according to the present invention.

FIG. 5 is a block diagram illustrating a computerized implementation of a method and system for selecting and applying variable thoroughfare travel fees according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience the Detailed Description of the Invention has the following sections:

I. General Description; and

II. Computerized Implementation.

### I. General Description

The present application discloses systems, methods, devices and program products for selecting and applying variable thoroughfare travel fees. Variable travel fees may be determined as a function of traveler or vehicle origin or destination indicia, for example through identifying a relation of a traveler to one or more impact regions as associated with property types of same and/or proximity to certain resources. In one aspect similar thoroughfare usage by similar travelers or vehicles may result in differentiated rates determined as a function of associated geographic property usage and characteristics. Additionally, as used in the present application the terms “toll” and “travel fee” refer not only to tolls or other fees associated with specific and designated toll or fee-for-use thoroughfares, but also to any fee or charge, or any credit or benefit, that may be assessed or awarded in association with a thoroughfare by a traveler. For example, a travel fee according to the present invention may comprehend a car-pool credit awarded, or a fee charged or debited from an account) in response to travel on any road, including free-ways and secondary roads, in traveling from an origin point to a destination point, and other examples will be apparent to one skilled in the art.

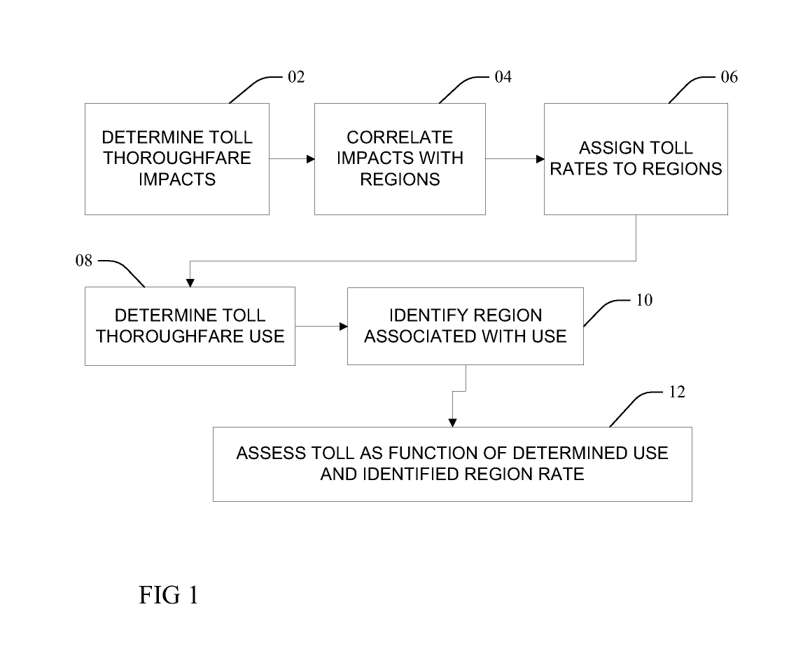

FIG. 1 illustrates one embodiment of the present invention wherein at 02 differentiated impacts associated with a thoroughfare toll are determined. A thoroughfare toll is a generic term that will be understood to represent charging any form of fee or toll for use of a public thoroughfare or public transportation. Although the most common form of a tolled thoroughfare is a toll road such as turnpike, tolls may also be assessed, or credits rewarded, for use of non-toll road; moreover, references to thoroughfares according to the present invention are not limited to vehicular roadways, and other illustrative but not exhaustive examples include canals, bridges and ferries, as well as mass passenger examples such as planes, trains, buses, lorries, ferries, taxicabs, boats, planes, etc. Vehicles may travel along dedicated thoroughfare infrastructure (e.g. railroad tracks), or define a thoroughfare through their regular paths and schedules (e.g. a shipping channel or inter-coastal waterway). Additionally, though toll thoroughfares are most commonly associated with user travel through private vehicles or other conveyance apparatus, their may also be utilized by users travelling under their own power (e.g. by bicycle or wheelchair), and also without any apparatus (by foot as a pedestrian over a toll bridge, or onto a ferry, etc.).

According to the present invention, determining differentiated impacts associated with a toll thoroughfare at 02 (FIG. 1) comprises determining and quantifying each of a plurality of different impacts that use and operation of the toll thoroughfare may have upon surrounding thoroughfares, regions, governmental entities, environmental contexts, etc., wherein each may support, encompass, or otherwise be affected by the toll thoroughfare, and more particularly as discussed more fully below. In one aspect, each of a plurality of differentiated impacts are determined and defined as different relative to each other, for example as further provided below.

Referring again to FIG. 1, at 04 the determined differentiated impacts are correlated with geographic impact regions proximate to the toll thoroughfare, the impact regions geographically distinct from each other, and at 06 one or more travel fees are assigned to each of the impact regions, the assigned impact region travel fees generally differentiated by impact region, in one aspect as a function of one or more differences between divergent impacts correlated with divergent regions. Locating the impact regions proximate to the toll thoroughfare will be understood in a generic sense, in that proximate may convey a physical proximity of an impact region to the toll thoroughfare, as well as an impact proximity; for example, pollution, noise and other noxious emissions from use of a toll thoroughfare may be conveyed through wind and waterways to a region physically remote from the toll thoroughfare, and the impact of said pollution emissions may be used to define said physically-remote region as a proximate impact region. Thus, according to the present invention, a proximate impact region may be defined as any geographic region or area within which property or occupants therein experience one or more of the determined and correlated impacts. The outer boundaries of impact regions may be determined through observing or determining a geographic distribution of pluralities of differentiated impacts, for example forming an outside boundary of each impact region in correlation with said geographic distributions, and further boundaries may be defined at locations wherein an observed or expected correlated impact diminishes or drops below an observable or other minimum threshold impact level.

At 08 (FIG. 1) a use of the toll thoroughfare by a traveler is determined or observed. A traveler according to the present invention is generic and may contemplate an individual person or group of persons, as well as a vehicle or other conveyance apparatus (e.g. boat, bicycle, wheelchair, etc.) or mode of self-conveyance (e.g. feet for pedestrian traffic, etc.) that triggers application of a toll for use of the toll thoroughfare. At 10 an association of the traveler or vehicle observed using the toll road at 08 is identified relative to one of the proximate impact regions, and at 12 a toll is charged to an appropriate entity (e.g. a traveler or a vehicle user, operator or owner or other party responsible for payment of tolls for the traveler) as a function of the thoroughfare use determined at 08 and the travel fee assigned to the impact region identified and associated with the user and the thoroughfare use.

In the implementation and management of mass transit and other travel thoroughfares, it is advantageous to consider environmental impact issues. For example, travel thoroughfare management may include a goal of increasing the green nature or earth/environment friendliness of a regional or national transit or travel system network. In one aspect it is possible to measure the environmental impact of a given toll thoroughfare, including determining a “carbon footprint” of use of the thoroughfare. A carbon footprint may be defined as a measure of the impact an activity has on the environment, and in particular with regard to thoroughfares as the amount of greenhouse gases produced in burning fossil fuels for traveler and cargo transportation activities on the thoroughfare. Greenhouse gases are believed to impact the environment through causing climate change, and thus it has become known to quantify the carbon footprint of an activity as the measurement of greenhouse gases produced, typically as an equivalent of carbon dioxide gases generated in units of tons or kilograms.

Determining differentiated impacts may comprise determining pluralities of different localized environmental impacts. In one aspect of the present invention the carbon footprint of a thoroughfare may be considered and a differentiated impact determined by observing or determining a contribution of traffic to each of a plurality of other road portions from a toll road, with traffic tolls set in order to minimize or reduce said footprint. Thus, some thoroughfare management entities may desire to balance the requirements and desires of commuters (e.g. decrease travel times by minimizing traffic congestion) with other objectives of regions impacted by use of the thoroughfare (e.g. reduce traffic on secondary roads by accommodating more vehicles on the toll thoroughfare, minimizing traffic jams experienced at ingress and egress points, reducing exhaust emissions proximate to the thoroughfare, encouraging bus use of the thoroughfare in order to achieve a net regional reduction in private vehicular traffic, etc.). Thoroughfare fare and toll management according to the present invention is thus responsive to regional needs, reducing the negative impacts of the thoroughfare on other proximate regions, in some examples by considering regional impacts through traffic congestion, environmental impact, availability and use of mass transit, equitable distribution of travel costs, etc. In contrast, prior art thoroughfare-centric management systems and methods generally increase such negative impacts by focusing solely on serving thoroughfare performance metrics.

The impact of existing thoroughfare infrastructure, as well as proposed infrastructure projects, may be considered in the context of impacts to a surrounding community or other regional entity, and in particular upon those persons, properties and resources in relatively close proximity to the thoroughfare. For example, it is known for residents within a community to object to a toll thoroughfare due to a variety of inconveniences caused by the thoroughfare, including additional vehicular traffic and noise caused in the community by access to and ingress from the thoroughfare, additional build-up and crowding of proximate communities encouraged by the presence of a popular toll thoroughfare, disruption of historical travel routes and alternatives, etc. Additionally, a toll road routed through a community may become the preferred/most efficient route for vehicular travel for that community, but a community resident is also forced to pay for use of the toll road route, in some examples also losing former non-toll road travel options incident to toll road routing, thus requiring fees where some former travel to certain destinations would not have incurred a fee.

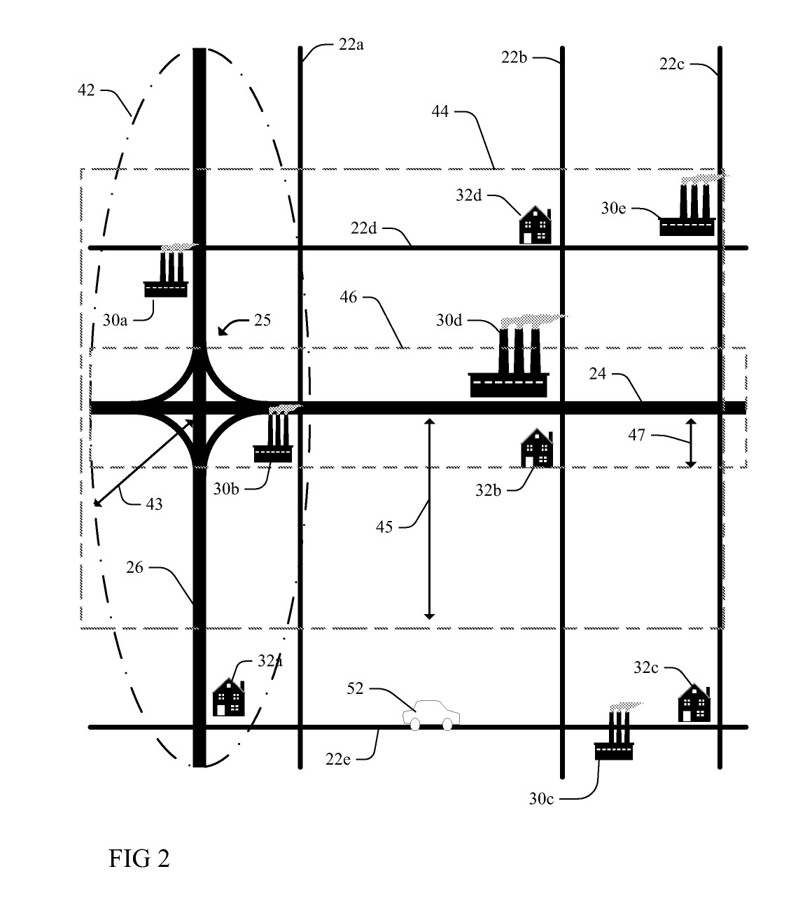

Referring now to FIG. 2, one implementation of a method or system according to the present invention for selecting and applying variable travel fees for use of a toll road 24 is illustrated. The present toll road 24 is a restricted-use, high-speed freeway, as is non-toll freeway 26 shown intersecting the toll road 24 in an on-ramp/off-ramp intersection/interchange 25. In one aspect, impact of the toll road 24 on surrounding regions may diminish in proportion to a distance of a given affected area from the toll road 24. Accordingly, divergent impact regions 42, 44 and 46 are defined and provided according to the present invention, configured for the application of variable tolls with respect to use of the toll road 24.

More particularly, the present invention determines and defines a high impact zone region 42 proximate to and centered about the interchange 25, for example in response to impacts from the toll road 24 determined at 02 (FIG. 1) and geographically correlated at 04 (FIG. 1) in the process and system described above. Disruption of traffic patterns on adjacent secondary roads 22 may be expected to occur through increased traffic endemic to use of the toll road 24 and freeway 26, and the extent and severity of said disruptions will be higher on those secondary roads 22 or portions thereof closest to the interchange 25 of the toll road 24 and freeway 26, and accordingly within the high impact zone 42 centered about the interchange 25.

Impact regions may also be defined in response to socioeconomic area determinations. Inconveniences experienced in the high impact zone 42 may include a general increase in traffic through a relatively higher concentration of road-side businesses 30a and 30b, in one aspect including additional fuel stations, convenience stores, and fast food restaurants 30a and/or 30b, the impact further determined as a function of the socioeconomic characteristics of the high impact zone 42. Thus, demographic data indicating a high density and relative population of low income residents within the zone 42 may indicate a higher negative impact from the presence of high concentrations of said fuel stations, convenience stores, and fast food restaurants, wherein other socioeconomic data (e.g. lower population density with higher average incomes) may instead find less negative impact, or even a positive impact, from a higher concentration of fuel stations, convenience stores, and fast food restaurants. A business may be understood to encompass a variety of commercial and non-profit activities, including professional services (e.g. legal, accounting and medical services and providers), office parks, wholesale and retail activities, industrial and manufacturing, warehousing and storage, social service providers, and still other business activities will be apparent to one skilled in the art. Higher business densities tend to slow local traffic flow, for example due to an increase in stop signs and traffic lights, and in patrons driving in and out of the businesses. In addition, increased neighborhood traffic may also occur in proximity to interchange 25 exits through drivers errantly exiting, and further using neighborhood side-streets 22 to turn around or perform u-turns to reverse direction and re-enter the toll road 24 or freeway 26. Also, crime statistics in a given community often show a relation to an ease in which a vehicle can come and go, with higher traffic flow generally related to higher numbers or frequencies of crime incidents.

The high impact zone 42 embodiment illustrated in FIG. 1 is defined by an outer generally elliptical radial boundary 43 centered on the interchange 25. This is a function of determining a geographic distribution of high negative impacts occurring or predicted to occur within the high impact zone 42, wherein in the present example the distribution indicates a much longer distribution along the freeway 26 relative to a shorter distribution along the toll road 24. The present unequal distribution along the freeway 26 relative to the toll road 24 may occur in response to a number of factors, and illustrative but not exhaustive examples include different relative zoning, taxing or property use restrictions applied to properties 30a, 32a, 30b, 30d and/or 32b as well as other properties along said roads 22/24/26; proximity of freeway 26 to a parallel side road 22a that carries more traffic than the side roads 22d and 22e parallel to the toll road 24; differentiate utility service favoring the impact area along freeway 26 over property along the toll road 24; and still other factors will be apparent to one skilled in the art.

Additionally, a second moderate impact zone 46 is determined and defined to encompass areas and properties along the toll road 24 within a moderate impact distribution distance boundary 47 from the toll road 24, wherein it is determined or predicted that areas and properties within the moderate impact zone 46 experience or may experience at least some of the impacts endemic to the high impact zone 42, but generally to a lesser degree. A third low impact zone 44 also is determined and defined to encompass areas and properties along the toll road 24 within a larger low impact distribution distance boundary 45 from the toll road 24, wherein it is determined or predicted that areas and properties within the low impact zone 44 experience or may experience at least some of the impacts endemic to the high impact zone 42 or the moderate impact zone 46, but generally to a lesser degree than the experience within the moderate impact zone 46. And finally, properties and areas outside of the zones 42/44/46 will typically see no significant change in traffic patterns or other associated issues.

Though geographically distinct the impact zones 42/44/46 of the embodiment of FIG. 1 may overlap, and in one aspect allocation to one of the overlapping zones 42/44/46 may be accomplished through a variety of methods and procedures. Thus, in one embodiment, the zone 42/44/46 with the highest degree or order may control, and thus business 30b may be considered as within the high impact zone 42 for toll setting according to the present invention; in other embodiments, a lowest order or ranking may be selected, and thus business 30b may instead be considered as within the moderate impact zone 46 for toll setting according to the present invention. One skilled in the art will understand that any number of policies may be considered and implemented to resolve a conflict between overlapping zones 42/44/46.

According to the present invention, travel fees for use of the toll road 24 are set as a function of an association with one of the zones 42/44/46, in some examples to provide some benefit or amelioration of impact detriments to persons associated with said zone 42/44/46. Thus, toll road 24 use associated with properties in proximity to the toll road 24 may receive a graduated, discounted toll fee based on property location, for example a vehicle registered to a business 30b within the high impact zone 42 may pay a lower travel fee than one registered to business 30d within the moderate zone 46. In some embodiments, a high impact zone 42 business 30b or resident 32a may pay no toll at all, for example in response to a policy determination that it would not be fair to require the high impact zone 42 resident to pay full rate as they may have no choice but to use the toll thoroughfare 24 or otherwise travel within the high impact zone 42; in contrast, those businesses 30d and residents 32b in the moderate impact zone 46 pay a reduced but relatively higher toll than that charged to the high impact zone 42 resident; and those businesses 30c or residents 32c outside of each of the impact zones 42/44/46 would pay a standard, or possibly even an increased, travel fee. In alternative examples, the high impact zone 42 resident may instead pay an enhanced or higher toll or rate, for example due to the relatively greater and more convenient access to the interchange 25.

Association of a toll road 24 user with a given impact zone 42/44/46 may be determined through a wide variety of methods and systems. For example, a user's residence, rental or other property address may be determined from one or more stored and available data records, databases or sources, in some embodiments from real estate records (including property deeds and/or plats records), postal service records, tax authority records, national records such as passport service records, and other appropriate data will be apparent to one skilled in the art. Toll road 24 user vehicle affiliations with property locations 30/32 may be identified and/or verified through stored and available data sources, in some embodiments from vehicle registration records, tax authority records, vehicle dealership sales records, and still other appropriate data will be apparent to one skilled in the art.

Business location 30 affiliation with a toll road 24 user may result in application of an appropriate impact zone rate 42/44/46, in some examples where said association indicates that the user is a regular commuter. Business location 30 affiliation may be determined or collected from one or more stored and available data sources, and illustrative but not exhaustive examples include employer records; tax authority records; and self-reported information provided by a commuter, in some embodiments subject to verification.

Businesses may also request or specify specific variable travel fees or payment agreements, in some examples responsive to their operations and other characteristics. Thus in one embodiment a business 30 may request an appropriate impact zone 42/44/46 travel fee be applied to toll road 24 use by their employees, optionally as identified and verified through real-time access to employer records. In some embodiments, an appropriate zone 42/44/46 status may enable a business 30 to charge employee inbound and outbound commuter tolls to a business toll account, in some embodiments at a differentiated commuter rate; for example, inbound tolls may be identified as those occurring between the specific hours of 7:00 AM and 9:00 AM, and outbound tolls those occurring between the hours of 3:00 PM and 6:00 PM; some businesses 30 may request that all tolls between 7:00 AM and 6:00 PM be considered as commuter tolls, particularly where several office buildings 30 may be distributed throughout a community. Commuter status may also be recognized or verified through toll road 24 use data analysis, for example determining a use pattern having regular frequency of trips using the same ingress and egress to the toll road, and in some embodiments further correlated with recognized business 30 hours or time of ingress and egress associated with proximity to a residence 32.

Travel fees within or without the impact zones 42/44/46 may also be differentiated with respect to property type. For example, an association with a primary type of property (e.g. the business 30e) may result in a primary toll rate different travel fee than from a secondary tool rate assigned as a result of an association with a secondary type of property (e.g. the residential property 32d) within the same moderate impact zone 44. In some embodiments a regular or automated data feed may be provided to a toll road 24 authority, automatically maintaining current residential records and/or registering new residents of a community for toll road 24 usage at an appropriate residential rate prescribed by a location of their property relative to the impact zones 42/44/46. Renters of residential properties 32 may also be charged tolls at a rate applicable to the property 32 as a function of the appropriate impact zones 42/44/46, and in some examples owner or renter status may be determined and travel fees further differentiated.

Identifying a relation of a traveler with an impact zone, property or property type may be accomplished though a variety of means. Illustrative but not exhaustive examples include recognizing a trip origin address of a traveler; a trip destination address of a traveler; a registration address of a vehicle utilized by a traveler; an operator address of the vehicle; and an owner address of a vehicle, and other examples will be apparent to one skilled in the art. Moreover, in addition to residence and place of employment, the present invention may also recognize and consider, or otherwise be extended to, other business and/or property relationships. For example, a client relationship may be recognized, and thus patients of a doctor's office 30 may receive an impact region 42/44/46 rate specified by the location of the doctor's office 30. Trucks and other cargo and shipping vehicles travelling the toll road 24 may also be charged based upon an origin or destination business 30 location within or without a one of the impact zones 42/44/46s, and other examples will be apparent to one skilled in the art.

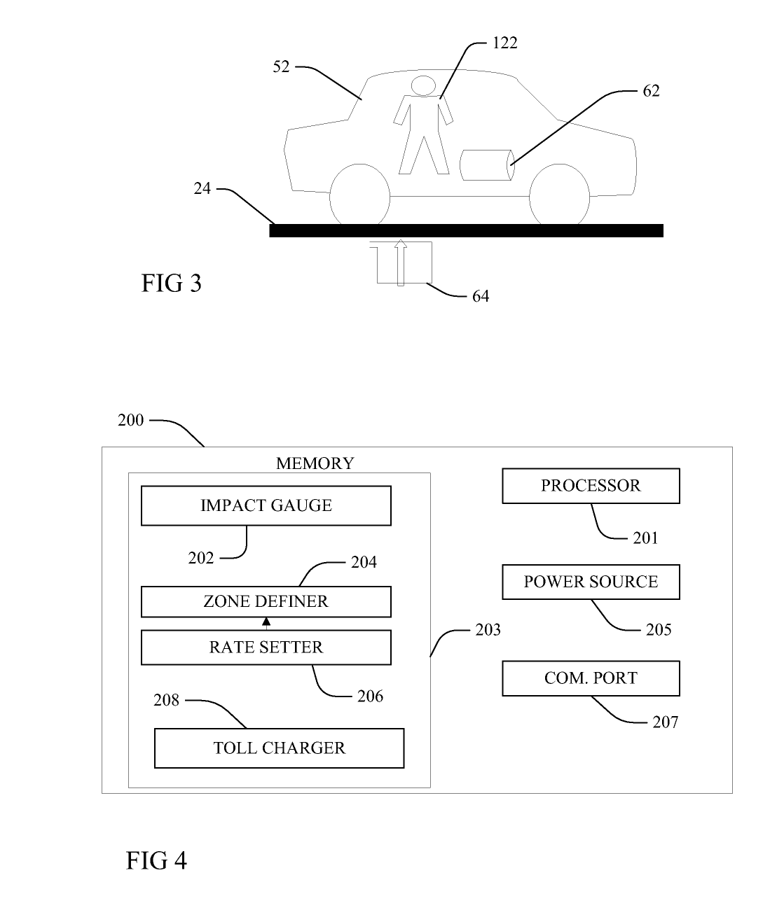

Data obtained and used with respect to the present invention may be stored and retained by the toll road 24 authority. Some embodiments may utilize one or more relational databases, which may provide advantages in scalability, ease of record association, and ease of data access for view and update. Referring now to FIG. 3, data may also be obtained from vehicle transponders 62 and/or toll road transponders 64. Thus in one embodiment a transponder 62 carried by or attached to a vehicle 52 is programmed with appropriate personal and business rate data, the data provided to a toll road 24 authority through wireless communication with the toll road transponder 64. The toll road transponder 64 may also directly scan vehicles 52 travelling by and identify an impact zone 42/44/46 association through other means, for example scanning license plate information and searching a vehicle registration database for a registration address correlated with a one of the zones 42/44/46.

Travel fees may be collected using manual and automated devices and systems, including fare boxes and automated toll collection systems (ETC), for example incorporating EZ-Pass® and/or SunPass® systems and the like (EZ-PASS is a Trademark of the EZ-Pass Interagency Group in the United States and/or other countries; SUNPASS is a trademark of the Florida Department of Transportation in the United States and/or other countries). Global Positioning Satellite (GPS) systems may also be used to track vehicle road use independent of toll road use and associated ETC systems, thus extending toll, fees and credit awards according to the present invention beyond conventional toll thoroughfares. Such automated embodiments offer advantages in enabling simplified implementation, management, and modification of variable rate tolls. In one embodiment discounts are only available to commuters equipped to use an ETC/GPS system, and in another embodiment a higher toll is paid by those commuters not equipped for ETC or GPS. In other examples a one-time discount, a temporarily reduced toll fee or a long term reduced toll fee is offered to entice commuters to switch to automated ETC or GPS systems. ETC and GPS systems may also comprehend municipal parking collection systems; vehicle service, fueling or charging stations, for example incorporated into automated fueling pumps or charging stations. Toll fees may also be assessed and collected through other payment and debiting systems and events, for example, upon payment of taxes, renewal of a drivers license, payment of regulated utility bill, and the like; or tolls may be invoiced for remittance by the vehicle 52 owner or operator, or even passenger 122 thereof.

The present invention thus provides for systems and methods of charging variable toll road fees to reduce or remove inhibitions regarding the use of existing, planned, and proposed toll thoroughfare systems, in one aspect by imposing equitably distributed fees, and also by providing incentives to impacted parties. It will also be appreciated that a variety of variable travel fee rewards may be utilized. Thus, in one embodiment, the high impact zone 42 may be designated a preferred business development area or zone 42, for example one having a high-density capacity or a mass-transit service advantage over the other zones 44/46 and outer areas, for example an outer area business 30c and residence 32c. For example, an efficiently designed high density/high impact zone 42 may present a lower overall carbon footprint for a similar population relative to the other zones 44/46 and outer area properties 30c/32c, and thus current and future residents may be encouraged to remain in or relocate to the high impact/preferred-development zone 42 by reducing travel fees relative to those charged for associations with the other zones 44/46 and outer area properties 30c/32c. In other embodiments rates higher impacts may instead be correlated with higher travel fees, for example increasing travel fees for the high-impact zone 42 relative to those charged for associations with the other zones 44/46 and outer area properties 30c/32c in order to encourage a reduction in density and impact activities with the high-impact zone 42, or to more equitably assess the costs of high impact activities directly upon those parties taking part in or enjoying the benefits of said activities.

FIG. 4 illustrates a programmable device or module 200 configured to select and apply variable toll thoroughfare rates according to the present invention, for example as illustrated in FIGS. 1-3 and described above. The device 200 may be incorporated into a large system wherein other components of the system accomplish systems and methods according to the present invention, or it may be a stand-alone device or module configured to perform each of the systems and methods, such as the transponder device or module 62/64 of FIG. 3. The present embodiment comprises a central processing unit (CPU) or other processing means 201 in communication with a memory 203, the memory 203 comprising logic components that enable the CPU 201 to perform processes and methods according to the present application, for example as discussed above with respect to FIGS. 1-3. Thus, the memory 203 comprises an impact determiner or gauge logic component 202, the determiner configured to determined impacts associated with a toll thoroughfare; an impact region or zone definer logic component 204, configured to determined the boundaries of an impact zone as a function of a distribution of toll thoroughfare impacts; a travel fee setter logic component 206, configured to assigned and set travel fees for each impact zone; and a toll charger logic component 208, configured to charge tolls for use of the toll thoroughfare correlated with an impact zone. A power unit 205 is configured to provide operative power to the device 200; examples include battery units 205 and power inputs configured to receive alternating or direct current electrical power, and other appropriate power units 205 will be apparent to one skilled in the art. A communication port or network link/node means 207 is also provided and configured to enable network and other communications with other devices, systems, monitoring, administrative and service provider entities, as well as others as appropriate.

### II. Computerized Implementation

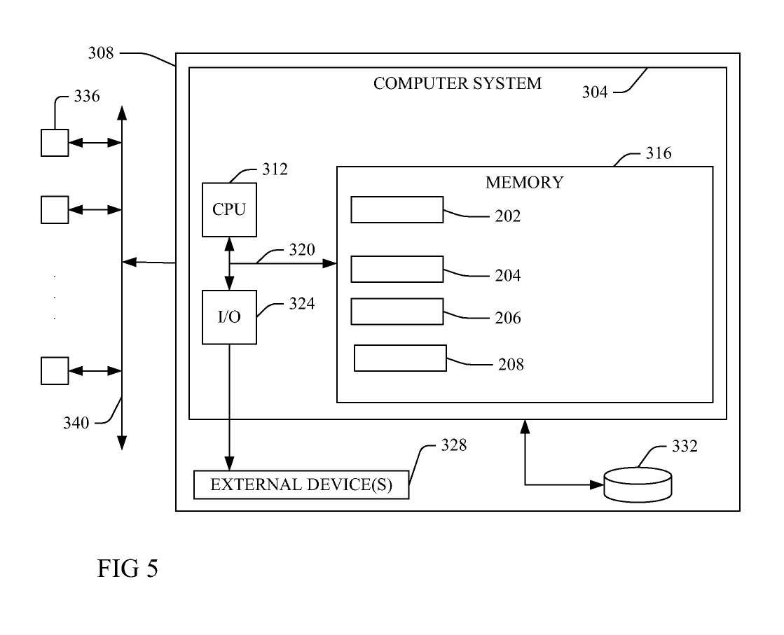

Referring now to FIG. 5, an exemplary computerized implementation of the present invention includes a computer system 304 deployed within a computer infrastructure 308 such as a computer or a programmable device such as a personal digital assistant (PDA) or cellular phone. This is intended to demonstrate, among other things, that the present invention could be implemented within a network environment 340 (e.g., the Internet, a wide area network (WAN), a local area network (LAN), a virtual private network (VPN), etc.) in communication with one or more additional computers 336, or on a stand-alone computer infrastructure 308. In the case of the former, communication throughout the network 340 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

As shown, the computer system 304 includes a central processing unit (CPU) 312, a memory 316, a bus 320, and input/output (I/O) interfaces 324. Further, the computer system 304 is shown in communication with external I/O devices/resources 328 and storage system 332. In general, the processing unit 312 executes computer program code, such as the code to implement various components of the process and systems, and devices as illustrated in FIGS. 1-4 and described above, including the impact gauge logic component 202, the zone definer logic component 204, the travel fee setter logic component 206 and the toll charger logic component 208 discussed above and, which are stored in memory 316 and/or storage system 332. It is to be appreciated that two or more, including all, of these components may be implemented as a single component.

While executing computer program code, the processing unit 312 can read and/or write data to/from the memory 316, the storage system 332, and/or the I/O interfaces 324. The bus 320 provides a communication link between each of the components in computer system 304. The external devices 328 can comprise any devices (e.g., keyboard, pointing device, display, etc.) that enable a user to interact with computer system 304 and/or any devices (e.g., network card, modem, etc.) that enable computer system 304 to communicate with one or more other computing devices.

The computer infrastructure 308 is only illustrative of various types of computer infrastructures for implementing the invention. For example, in one embodiment, computer infrastructure 308 comprises two or more computing devices (e.g., a server cluster) that communicate over a network to perform the various process steps of the invention. Moreover, computer system 304 is only representative of various possible computer systems that can include numerous combinations of hardware.

To this extent, in other embodiments, the computer system 304 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively. Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations.

Further, I/O interfaces 324 can comprise any system for exchanging information with one or more of the external device 328. Still further, it is understood that one or more additional components (e.g., system software, math co-processing unit, etc.) not shown in FIG. 4 can be included in computer system 304. However, if computer system 304 comprises a handheld device or the like, it is understood that one or more of the external devices 328 (e.g., a display) and/or the storage system 332 could be contained within computer system 304, not externally as shown.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN) or a storage area network (SAN) (not shown). In addition, although not shown, additional components, such as cache memory, communication systems, system software, etc., may be incorporated into computer system 304.

While shown and described herein as a method and a system, it is understood that the invention further provides various alternative embodiments. For example, in one embodiment, the invention provides a computer-readable/useable medium that includes computer program code to enable a computer infrastructure to implement methods, systems and devices according to the present application, for example as illustrated in FIGS. 1-4 above and described otherwise herein. To this extent, the computer-readable/useable medium includes program code that implements each of the various process steps of the present application.

It is understood that the terms “computer-readable medium” or “computer useable medium” comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 316 and/or the storage system 332 (e.g., a fixed disk, a read-only memory, a random access memory, a cache memory, etc.), and/or as a data signal (e.g., a propagated signal) traveling over a network (e.g., during a wired/wireless electronic distribution of the program code).

Still yet, computer infrastructure 308 is intended to demonstrate that some or all of the components of implementation according to the present application could be deployed, managed, serviced, etc. by a service provider who offers to implement, deploy, and/or perform the functions of the present invention for others, for example by licensing methods and browser or application server technology to an internet service provider (ISP) or a cellular telephone provider. In one embodiment, the invention may comprise a business method that performs the process steps of the invention on a subscription, advertising, and/or fee basis. Thus, a service provider can create, maintain, support, etc., a computer infrastructure, such as the computer infrastructure 308 that performs the process steps of the present application for one or more customers, and in return the service provider can receive payment from the customer(s) under a subscription and/or fee agreement and/or the service provider can receive payment from the sale of advertising content to one or more third parties.

In still another embodiment, the invention provides a computer-implemented method for enabling the processes, methods and devices according to the present application. In this case, a computer infrastructure, such as computer infrastructure 308, can be provided and one or more systems for performing the process steps of the invention can be obtained (e.g., created, purchased, used, modified, etc.) and deployed to the computer infrastructure. To this extent, the deployment of a system can comprise one or more of: installing program code on a computing device, such as computer system 304, from a computer-readable medium; adding one or more computing devices to the computer infrastructure; and incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

Certain examples and elements described in the present specification, including in the claims and as illustrated in the Figures, may be distinguished or otherwise identified from others by unique adjectives (e.g. a “first” element distinguished from another “second” of a plurality of elements, a “primary” distinguished from a “secondary,” an “another”, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for selecting and applying variable thoroughfare travel fees, comprising:
determining each of a plurality of differentiated impacts associated with a toll thoroughfare, wherein each one of the differentiated impacts is different from another of the differentiated impacts;
correlating one each of the determined plurality of differentiated impacts with at least one each of a plurality of geographic impact regions, wherein each one of the impact regions is proximate to the toll thoroughfare and geographically distinct from another of the impact regions;
assigning a travel fee to each of the impact regions, each one of the assigned impact region travel fees different from another of the assigned impact region travel fees;
determining a use of the toll thoroughfare by a traveler;
identifying a relation of the traveler to a first of the impact regions; and
charging a toll as a function of the determined toll thoroughfare use and the travel fee of the first impact region.

2. The method of claim 1, the identifying the relation of the traveler comprising recognizing at least one of:
a trip origin address of the traveler;
a trip destination address of the traveler;
a registration address of a vehicle utilized by the traveler;
an operator address of the vehicle; and
an owner address of the vehicle as a location within the first impact region.

3. The method of claim 2, wherein the thoroughfare is a toll road, the determining the differentiated impacts comprising determining a contribution of traffic to each of a plurality of other road portions from the toll road; and
the correlating the differentiated impacts comprising defining each of the geographic impact regions as encompassing a one of the other road portions.

4. The method of claim 2, the determining the differentiated impacts comprising determining a plurality of different localized environmental impacts; and
the correlating the differentiated impacts comprising defining each of the geographic impact regions as an area encompassing a one of the plurality of different localized environmental impacts.

5. The method of claim 2, comprising:
determining a geographic distribution of the determined plurality of differentiated impacts; and
forming an outside boundary of each of the impact regions in correlation with the determined geographic distribution.

6. The method of claim 2, the assigning the travel fee to the first impact region comprising:
assigning a primary rate to a primary type of property; and
assigning a secondary rate to a secondary type of property, the secondary rate different than the primary rate;
the recognizing the location comprising determining the location is a primary type of property; and
setting the travel fee as the primary rate in response to determining the location is a primary type of property.

7. The method of claim 6, comprising:
defining the primary type of property as a residential property use; and
defining the secondary type of property as a business property use.

8. The method of claim 2, comprising defining a first socioeconomic area and a second socioeconomic area within the first impact region;
the assigning the travel fee to the first impact region comprising assigning a first socioeconomic area travel fee to the first socioeconomic area and a second socioeconomic area travel fee to the second socioeconomic area, the second socioeconomic area travel fee different from the first socioeconomic area travel fee; and
the recognizing the address comprising recognizing the property location as encompassed within the first socioeconomic area or within the second socioeconomic area.

9. The method of claim 8, wherein the first socioeconomic area is a business development area, and wherein the first socioeconomic area travel fee is lower than the second socioeconomic area travel fee.

10. A service for selecting and applying variable thoroughfare travel fees, comprising:
providing a computer infrastructure configured to:
determine each of a plurality of differentiated impacts associated with a toll thoroughfare, wherein each one of the differentiated impacts is different from another of the differentiated impacts;
correlate one each of the determined plurality of differentiated impacts with at least one each of a plurality of geographic impact regions, wherein each one of the impact regions is proximate to the toll thoroughfare and geographically distinct from another of the impact regions;
assign a travel fee to each of the impact regions, each one of the assigned impact region travel fees different from another of the assigned impact region travel fees;
determine a use of the toll thoroughfare by a traveler;
identify a relation of the traveler to a first of the impact regions; and
charge a toll as a function of the determined toll thoroughfare use and the travel fee of the first impact region.

11. The service of claim 10, wherein the thoroughfare is a toll road, the computer infrastructure configured to:
determine the differentiated impacts by determining a contribution of traffic to each of a plurality of other road portions from the toll road; and
correlate the differentiated impacts by defining each of the geographic impact regions as encompassing a one of the other road portions.

12. The service of claim 10, wherein the computer infrastructure configured to:
determine the differentiated impacts by determining a plurality of different localized environmental impacts; and
correlate the differentiated impacts by defining each of the geographic impact regions as an area encompassing a one of the plurality of different localized environmental impacts.

13. A method for selecting and applying variable thoroughfare travel fees, comprising:
producing computer executable program code;
storing the code on a computer readable medium; and
providing the program code to be deployed and executed on a computer system, the program code comprising instructions which, when executed on the computer system, cause the computer system to:
determine each of a plurality of differentiated impacts associated with a toll thoroughfare, wherein each one of the differentiated impacts is different from another of the differentiated impacts;
correlate one each of the determined plurality of differentiated impacts with at least one each of a plurality of geographic impact regions, wherein each one of the impact regions is proximate to the toll thoroughfare and geographically distinct from another of the impact regions;
assign a travel fee to each of the impact regions, each one of the assigned impact region travel fees different from another of the assigned impact region travel fees;
determine a use of the toll thoroughfare by a traveler;
identify a relation of the traveler to a first of the impact regions; and
charge a toll as a function of the determined toll thoroughfare use and the travel fee of the first impact region.

14. The method of claim 13, the program code comprising instructions which, when executed on the computer system, causes the computer system to identify the relation of the traveler by recognizing at least one of:
a trip origin address of the traveler;
a trip destination address of the traveler;
a registration address of a vehicle utilized by the traveler;
an operator address of the vehicle; and
an owner address of the vehicle as a location within the first impact region.

15. The method of claim 14, wherein the thoroughfare is a toll road, the program code comprising instructions which, when executed on the computer system, causes the computer system to:
determine the differentiated impacts by determining a contribution of traffic to each of a plurality of other road portions from the toll road; and
correlate the differentiated impacts by defining each of the geographic impact regions as encompassing a one of the other road portions.

16. The method of claim 14, the program code comprising instructions which, when executed on the computer system, causes the computer system to:
determine the differentiated impacts by determining a plurality of different localized environmental impacts; and
correlate the differentiated impacts by defining each of the geographic impact regions as an area encompassing a one of the plurality of different localized environmental impacts.

17. A programmable device comprising:
a processing means;
a memory in communication with the processing means comprising a logic component; and
a network in communication with the processing means and the memory;
wherein the processing means is configured to:
determine each of a plurality of differentiated impacts associated with a toll thoroughfare, wherein each one of the differentiated impacts is different from another of the differentiated impacts;
correlate one each of the determined plurality of differentiated impacts with at least one each of a plurality of geographic impact regions, wherein each one of the impact regions is proximate to the toll thoroughfare and geographically distinct from another of the impact regions;
assign a travel fee to each of the impact regions, each one of the assigned impact region travel fees different from another of the assigned impact region travel fees;
determine a use of the toll thoroughfare by a traveler;
identify a relation of the traveler to a first of the impact regions; and
charge a toll as a function of the determined toll thoroughfare use and the travel fee of the first impact region.

18. The programmable device of claim 17, wherein processing means is configured to identify the relation of the traveler by recognizing at least one of:
a trip origin address of the traveler;
a trip destination address of the traveler;
a registration address of a vehicle utilized by the traveler;
an operator address of the vehicle; and
an owner address of the vehicle as a location within the first impact region.

19. The programmable device of claim 18, wherein processing means is configured to:
assign the travel fee to the first impact region by assigning a primary rate to a primary type of property and assigning a secondary rate to a secondary type of property, the secondary rate different than the primary rate;
recognize the location by determining the location is a primary type of property; and
set the travel fee as the primary rate in response to determining the location is a primary type of property.

20. The programmable device of claim 18, wherein processing means is configured to:
define the primary type of property as a residential property use; and
define the secondary type of property as a business property use.
